(19) United States
(12) Patent Application Publication
(10) Pub. No.: US 2015/0215947 A1
(43) Pub. Date: Jul. 30, 2015

(54) APPARATUS AND METHODS FOR INTERFERENCE MITIGATION

(71) Applicant: Broadcom Corporation, Irvine, CA (US)

(72) Inventors: Jouni Kaukovuori, Vantaa (FI); Antti Immonen, Helsinki (FI); Christopher Callender, Kinross (EN)

(21) Appl. No.: 14/420,048

(22) PCT Filed: Aug. 9, 2013
(86) PCT No.: PCT/IB2013/056536

§ 371 Date: Feb. 6, 2015

(30) Foreign Application Priority Data
Aug. 9, 2012 (GB) 1214257.6

(51) Int. Cl. H04W 72/08; H04W 72/04

(52) U.S. Cl. CPC H04W 72/082; H04W 72/0453

(57) ABSTRACT

Measures for mitigating interference in wireless communications of a user equipment comprising a plurality of radio transceivers. The user equipment determines that wireless communication using a given combination of uplink and/or downlink carrier bands associated with the plurality of radio transceivers causes an interference scenario. In response to the determination, the user equipment transmits, into a radio network, an indication of at least one preferred uplink carrier band for at least one of the plurality of radio transceivers. The indication transmitted by the user equipment is received at a network node in the radio network which may choose to carryout radio resource control in the radio network at least on the basis of the received indication.

### TECHNICAL FIELD

The present disclosure relates to interference mitigation. In particular, but not exclusively, the present disclosure relates to methods, apparatus, computer software and computer program products for mitigating interference in wireless communications of a user equipment comprising a plurality of radio transceivers.

### BACKGROUND

At present, in 3GPP TS25.101, DB-DC-HSDPA or dual-band 4C-HSDPA configurations are specified for band combinations I+VIII, II+IV, I+V, I+XI, and II+V. In addition, approximately 20 inter-band combinations are accepted as 3GPP working group RAN4 work items with new combinations being introduced from time to time. The table in FIG. 1 summarises the current situation with inter-band CA cases according to active 3GPP work items for working group RAN4. Operator names indicate the operator(s) who are likely to use each combination, although it should be understood that this will not form part of any inter-band CA specifications.

Inter-band CA or dual-carrier HSDPA with only one active UL can produce harmonic intermodulation distortion at another DL. For example, as illustrated in FIG. 2, in a CA case of B17+B4 (i.e. ‘a carrier aggregation of band 17 with band 4’), the 3rd order harmonic component H3 of the B17 transmitter overlaps with the B4 DL band, thus desensitizing the receiver.

Furthermore, in order to allow users to access various networks and services ubiquitously, an increasing number of UEs are equipped with multiple radio transceivers. For example, a UE may be equipped with LTE, Wi-Fi™, Bluetooth™ transceivers and GNSS receivers. FIG. 3 shows such inter-RAT combinations where H3 results are produced in (or ‘on top of’) a non 3GPP band, such as used in a WLAN system. For example, in a CA case of B5+B3, the active cellular UL on Band 5 or Band 3 can cause desense on 2.4-GHz ISM, as illustrated in the upper part of FIG. 3, or 5-GHz WLAN receivers, as illustrated in the lower part of FIG. 3, respectively. One resulting challenge lies in trying to avoid coexistence interference between such collocated radio transceivers.

Due to the extreme proximity of multiple radio transceivers within the same UE, the transmit power of one transmitter may be much higher than the received power level of another receiver. By means of filter technologies and sufficient frequency separation, the transmit signal may not result in significant interference. However, for some coexistence scenarios, for example different radio technologies within the same UE operating on adjacent frequencies, current state-of-the-art filter technology might not provide sufficient rejection. Therefore, solving the interference problem by single generic RF design may not always be possible and alternative methods need to be considered.

Although there might be a single active cellular UL in CA, there can still be another active UL within a UE when connectivity radio is being operated simultaneously. Combining two carriers on different frequencies produces intermodulation distortion due to nonlinearities in active and passive components. For instance, 2nd order intermodulation components are produced at frequencies given by FIM2=FUL_high±FUL_low and 3rd order intermodulation component are produced at frequencies given by FIMD3=2*FUL1±FUL2, and so on.

A simplified figure illustrating 3rd order intermodulation generation is shown in FIG. 4. The two ULs have different BWs to illustrate the effect of the resulting intermodulation; the tone closer to the IMD3 frequency has twice the effect on the resulting IMD3 BW. In addition, a similar effect applies to the power. For example, when 2.4-GHz ISM radio is active with B7 UL, the DL of B7 suffers from desense caused by IMD3. The desense is merely a challenge for the main receiver since a diversity receiver does not have its own active transmitter at the same antenna port (although part of the active TX can still leak via finite antenna isolation).

In intermodulation problem cases, filtering can be used only to a certain extent because the power level of intermodulation components is dependent on the power level of transmitted powers, FE components linearity, antenna isolation, and k-factor. None of the aforementioned factors can be affected by filtering (although in theory, one exception to this might be antenna isolation). If an intermodulation component is produced just on top of the receiver, filtering will not provide any improvement. If an intermodulation component is produced partially on top of the receiver, then filtering can offer some improvement.

The interference problem could be mitigated by using a large amount of A-MPR. In single band LTE (3GPP Rel8/9/10) the maximum output power may be restricted by NS values. NS gives a certain amount of A-MPR (≧0 dB), which is an amount of relaxation in relation to maximum allowed output power. It should be noted that A-MPR is a band-specific value in current 3GPP specifications.

In single band LTE operation, NS band-specific NS values are defined in such a way that the operation meets requirements. Inter-band CA is an evolutionary step from single band operation. Also, Nokia™ has proposed NS signalling for CA. However, signalling NS values for the PCell does not provide an optimum solution for many potential cases and cannot solve inter-RAT cases.

In IDC, autonomous denial is currently under discussions in 3GPP RAN2. There is an agreement that autonomous denial can be used in cases where other solutions (DRX reception etc.) do not work. So far, only single-carrier LTE has been considered. In the IDC area, it has been proposed to implement signalling such that if a certain cellular frequency causes IDC problems, it is signalled to the network and then the problematic frequency is most probably deactivated.

There is therefore a need to improve UE overall performance across challenging scenarios, including measures to mitigate interference in wireless communications involving user equipment.

### SUMMARY

In accordance with first embodiments, there is provided a method of mitigating interference in wireless communications of a user equipment comprising a plurality of radio transceivers, the method comprising, at the user equipment:

determining that wireless communication using a given combination of uplink and/or downlink carrier bands associated with the plurality of radio transceivers causes an interference scenario; and

in response to the determination, transmitting, into a radio network, an indication of at least one preferred uplink carrier band for at least one of the plurality of radio transceivers.

In accordance with second embodiments, there is provided apparatus for use in mitigating interference in wireless communications of a user equipment comprising a plurality of radio transceivers, the apparatus being adapted to, at the user equipment:

determine that wireless communication using a given combination of uplink and/or downlink carrier bands associated with the plurality of radio transceivers causes an interference scenario; and

in response to the determination, transmit, into a radio network, an indication of at least one preferred uplink carrier band for at least one of the plurality of radio transceivers.

In accordance with third embodiments, there is provided a method of mitigating interference in wireless communications of a user equipment comprising a plurality of radio transceivers, the method comprising, at a network node:

receiving, from the user equipment via a radio network, an indication of at least one preferred uplink carrier band for at least one of the plurality of radio transceivers, the indication having been received in response to a determination by the user equipment that wireless communication using a given combination of uplink and/or downlink carrier bands associated with the plurality of radio transceivers causes an interference scenario.

In accordance with fourth embodiments, there is provided apparatus for use in mitigating interference in wireless communications of a user equipment comprising a plurality of radio transceivers, the apparatus being adapted to, at a network node:

receive, from the user equipment via a radio network, an indication of at least one preferred uplink carrier band for at least one of the plurality of radio transceivers, the indication having been received in response to a determination by the user equipment that wireless communication using a given combination of uplink and/or downlink carrier bands associated with the plurality of radio transceivers causes an interference scenario.

In accordance with fifth embodiments, there is provided computer software adapted to perform the method of the first embodiments.

In accordance with sixth embodiments, there is provided a computer program product comprising a computer-readable storage medium having computer readable instructions stored thereon, the computer readable instructions being executable by a computerized device to cause the computerized device to perform the method of the first embodiments. In embodiments, the computer-readable storage medium comprises a non-transitory computer-readable storage medium.

In accordance with seventh embodiments, there is provided computer software adapted to perform the method of the third embodiments.

In accordance with eighth embodiments, there is provided a computer program product comprising a computer-readable storage medium having computer readable instructions stored thereon, the computer readable instructions being executable by a computerized device to cause the computerized device to perform the method of the third embodiments. In embodiments, the computer-readable storage medium comprises a non-transitory computer-readable storage medium.

Further features and advantages of embodiments will become apparent from the following description of preferred embodiments, given by way of example only, which is made with reference to the accompanying drawings.

### BRIEF DESCRIPTION OF THE DRAWINGS

FIG. 1 summarises current inter-band CA combinations according to active 3GPP work items for working group RAN4 according to the prior art;

FIG. 2 depicts third order harmonic intermodulation distortion produced during CA of band 17 with band 4 according to the prior art;

FIG. 3, upper part, depicts an inter-RAT combination where third order harmonic intermodulation distortion is produced in a non 3GPP 2.4-GHz ISM band during CA of band 5 and band 3 according to the prior art;

FIG. 3, lower part, depicts an inter-RAT combination where third order harmonic distortion is produced in a non 3GPP 5-GHz WLAN band during CA of band 5 and band 3 according to the prior art;

FIG. 4 depicts third order intermodulation distortion generated on a DL band due to use of two UL bands according to the prior art;

FIG. 5 depicts different levels of third order intermodulation distortion produced during carrier aggregation of band 17 with band 4 according to embodiments;

FIG. 6, upper part, depicts third order harmonic intermodulation distortion being produced in a WLAN band during non-contiguous intra-band CA of band 3 according to the prior art;

FIG. 6, lower part, depicts avoidance of third order harmonic intermodulation distortion in a WLAN band during non-contiguous intra-band CA of band 3 according to embodiments;

FIG. 7, upper part, depicts third order harmonic intermodulation distortion being produced in an ISM band during use of band 5 according to embodiments;

FIG. 7, lower part, depicts second order harmonic intermodulation distortion being produced in a GPS band during use of band 5 and an ISM band according to embodiments;

FIG. 8 shows a flowchart according to embodiments of the present disclosure;

FIG. 9 shows a flowchart according to embodiments of the present disclosure; and

FIG. 10 shows a functional block diagram of apparatus according to embodiments of the present disclosure.

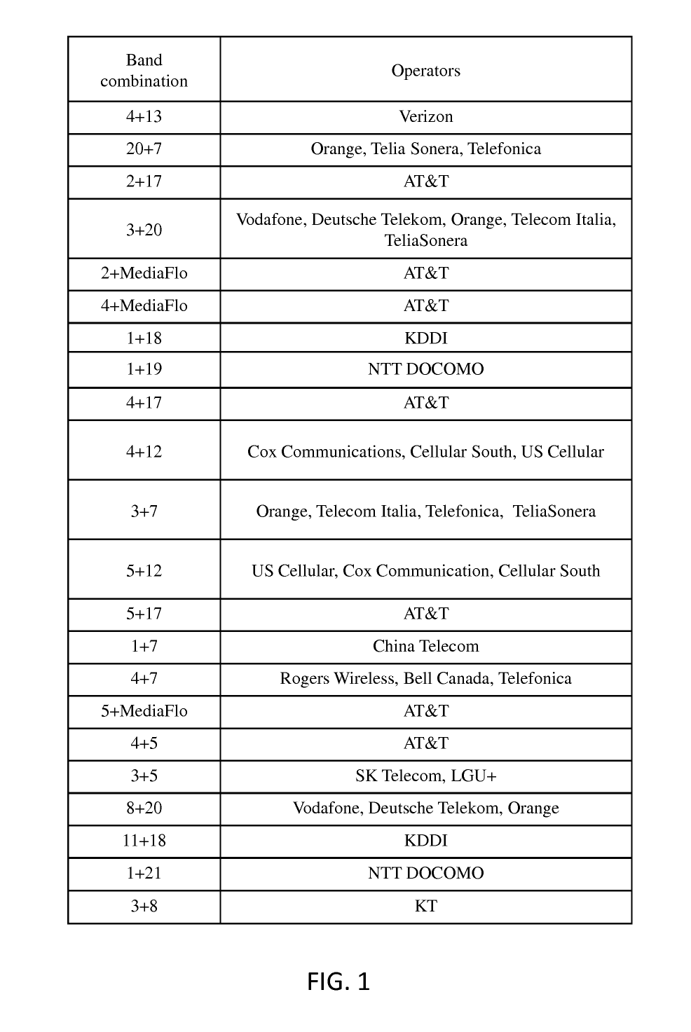

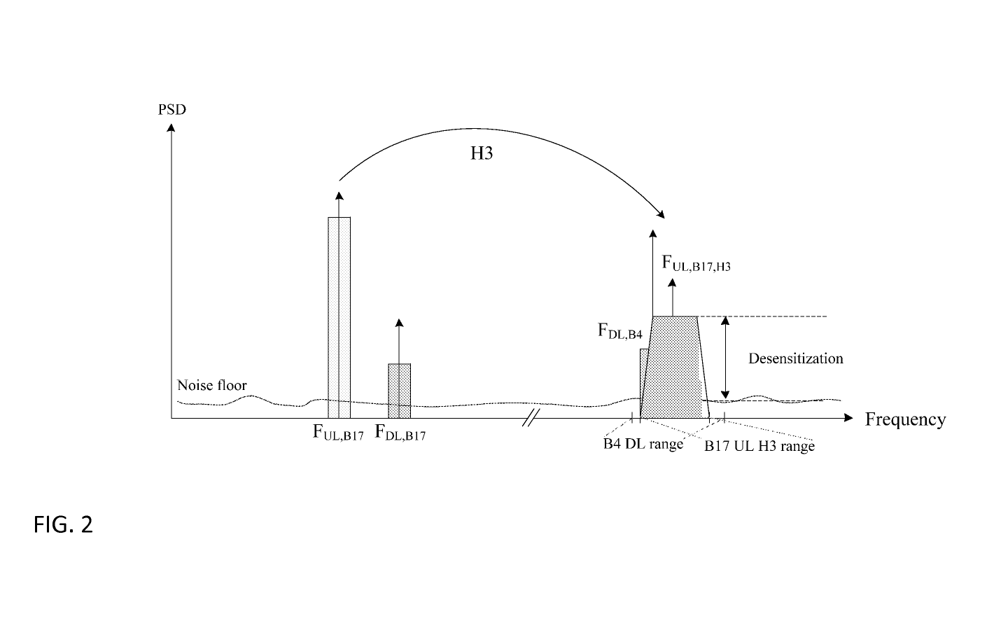

### DETAILED DESCRIPTION

Embodiments of the present disclosure are for example applicable to multi-band HSDPA and LTE operation, carrier aggregation, and multi-RAT wireless communications. Two or more radio transceivers operating concurrently may cause interference problems for the reception of some downlink or downlinks, or received signals from a broadcast system such as GPS. Embodiments of the present disclosure introduce measures to improve UE overall performance across challenging scenarios. Embodiments of the present disclosure are efficient with multi-band HSDPA and/or LTE CA with a single active cellular UL.

In carrier aggregation, there is additional freedom compared with single carrier configurations. This is especially true for 2DL/1UL carrier aggregation, since the uplink carrier could be paired with either of the downlink frequencies, for example by swapping which cell is the PCell. Since the UE is best aware of its capabilities (for example according to characteristics such as linearity, sensitivity, selectivity, blocking immunity, RF filter performance, spurious response rejection, etc.), activity at antenna ports (for example power of different ULs, received signal strengths) and/or the particular use case (for example expected data load at different radios), it is possible to predict what would be the best cellular link(s) to use at a certain time to optimize the overall data load the UE can handle. Alternatively, power consumption could be decreased if challenging co-existence scenarios are to be avoided and maximum linearity is not specifically required.

Spurious response rejection referred to in the preceding paragraph is typically defined as the capability of the receiver to discriminate between the wanted modulated signal at the nominal frequency and an unwanted signal at any other frequency at which a response is obtained.

Embodiments of the present disclosure introduce a UE capability or event to inform a network node in the radio network, such as a basestation, eNB, access node or suchlike, of a band and/or CC configuration which would cause less performance limitation over some or all active radios within the UE. Thus, embodiments provide improvement of the overall data speed, capability, power consumption and/or user experience for a UE.

Embodiments assist in mitigating interference scenarios involving in-device problems, (i.e. problems within the UE), which the network node cannot determine itself without the assistance of the UE.

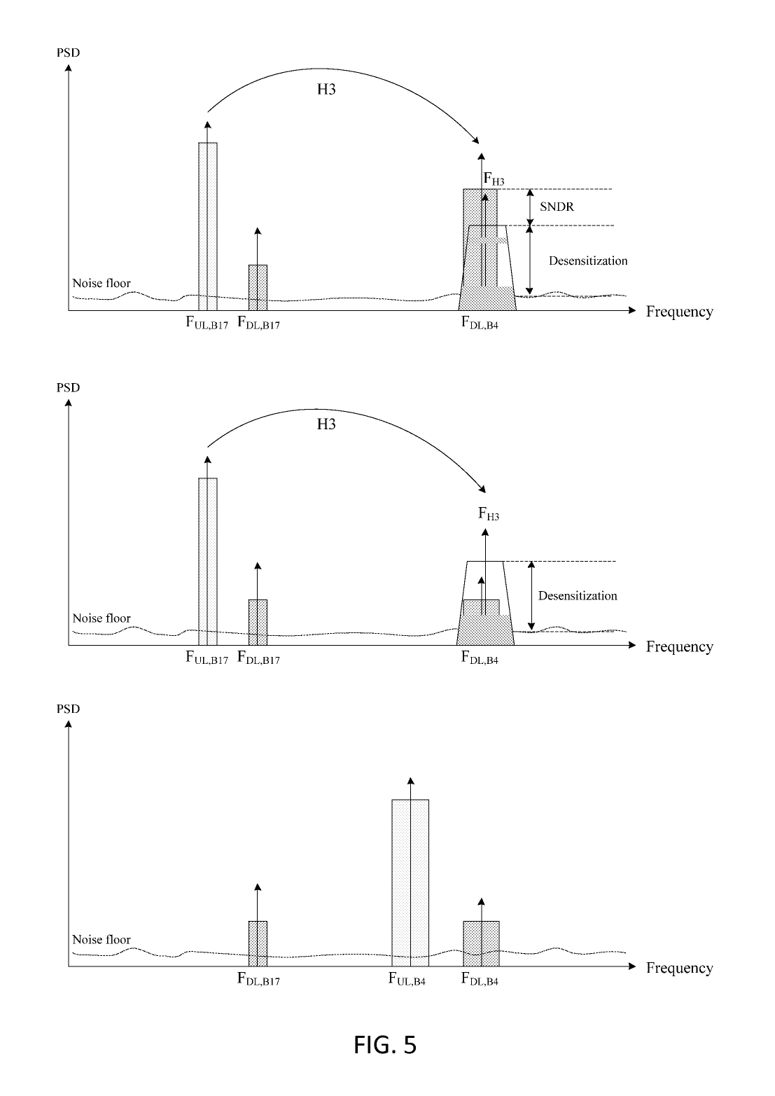

As mentioned above, in a CA case of B4+B17, the B17 UL causes 3rd order harmonic distortion over the B4 DL thus desensitizing the B4 receiver if it is operating close to the sensitivity level. Therefore, according to embodiments, depending on the received signal strength on B4 DL, the UE indicates which of the ULs (B17 or B4) is more optimal for its current use to the network. Hence, in embodiments, UL operation on B17 is allowed in favourable conditions and the UL activity is not limited to B4 only (poorer coverage due to much higher carrier frequency). An example of such embodiments is depicted in FIG. 5.

In the upper scenario illustrated in FIG. 5, the received B4 DL signal quality is good enough such that transmission on UL B17 is tolerated.

In the middle scenario illustrated in FIG. 5, the B4 DL received signal strength is much lower than in the first situation, thus the 3rd order harmonic of the B17 UL causes severe desensitization on the B4 receiver. Such a scenario could have been avoided if the UE had signalled the challenging situation to the network. In embodiments, the UE could signal such a challenging scenario in advance on the basis of forthcoming UL transmission power, received signal strength, harmonic performance, etc.

In the lower scenario illustrated in FIG. 5, the UE signals the challenging situation to the network and the network switches UL from B17 to B4 instead. The harmonic content in DL B4 is thus avoided.

It is anticipated that in future will also be other CA band combinations with similar characteristics (for example B3+B8, APAC700+B1, where APAC700 is B28, etc). Furthermore, it is anticipated that there will be large variation between different UEs in actual performance with respect to 3rd order harmonic leakage to the downlink. For instance, US operators tend to have a strong influence on the required performance of the devices they sell in theirs stores with their subscriptions. Thus, it can be anticipated that the performance of those UE's will be good, in many cases clearly better than performance required by 3GPP standards. However, there are also devices in the field that are not sold by US vendors, which are not necessarily designed according to the requirements of US vendors but instead designed to meet 3GPP specifications. Thus the performance of these devices can clearly be different from those sold by the US vendors, hence leading to a different trade-off between desensitization and power consumption, for example (3rd order harmonics desensitize high-band DL). Thus, devices with good performance can more probably operate even with low-band UL (e.g. lower than 1.5 GHz), but devices with poorer performance can operate only with high-band UL (e.g. higher than 1.5 GHz) in order not to desense the high-band DL too much. Thus, it is highly beneficial to have measures according to embodiments for the UE to “suggest” to a network node such as an eNB a preferred UL to use.

Embodiments involve measures, including methods, apparatus, computer software and computer program products, for mitigating interference in wireless communications of a UE comprising a plurality of radio transceivers.

The UE determines that wireless communication using a given combination of uplink and/or downlink carrier bands associated with the plurality of radio transceivers causes an interference scenario. In response to the determination, the UE transmits, into a radio network, an indication of at least one preferred uplink carrier band for at least one of the plurality of radio transceivers.

The indication transmitted by the UE is received at a network node in the radio network, for example a base station, eNB, access node or suchlike.

In embodiments, the network node carries out radio resource control in the radio network at least on the basis of the received indication.

In embodiments, the indication of the at least one preferred uplink carrier band comprises an indication of at least one preferred uplink carrier band for carrier aggregation. In such embodiments, the network node may initiate configuration of carrier aggregation in the radio network for the UE on the basis of the received indication of at least one preferred uplink carrier band.

In embodiments, the indication of the at least one preferred uplink carrier band comprises an indication of a preferred uplink carrier band for a change of primary serving cell. In such embodiments, the network node may initiate change of primary serving cell for the user equipment on the basis of the received indication of a preferred uplink carrier band.

In some embodiments, the determination is made by the UE when communication using the given combination is taking place via the UE. In other embodiments, the determination is made by the UE before communication using the given combination takes place via the UE.

In embodiments, the radio network comprises a cellular network and the indication comprises an indication of at least one preferred uplink carrier band for the cellular network.

In embodiments, the plurality of radio transceivers comprises at least one uplink transmitter and at least two downlink receivers and the indication comprises an indication of at least one preferred uplink carrier band for the at least one uplink transmitter for use during downlink carrier aggregation via the at least two downlink receivers. Hence, embodiments apply during 1UL+2DL operation.

In embodiments, the plurality of radio transceivers comprises at least two uplink transmitters and at least two downlink receivers and the indication comprises an indication of at least one preferred uplink carrier band for one or more of the at least two uplink transmitters for use during downlink carrier aggregation via the at least two downlink receivers and uplink carrier aggregation via the at least two uplink transmitters. Hence, embodiments apply during 2UL+2DL operation.

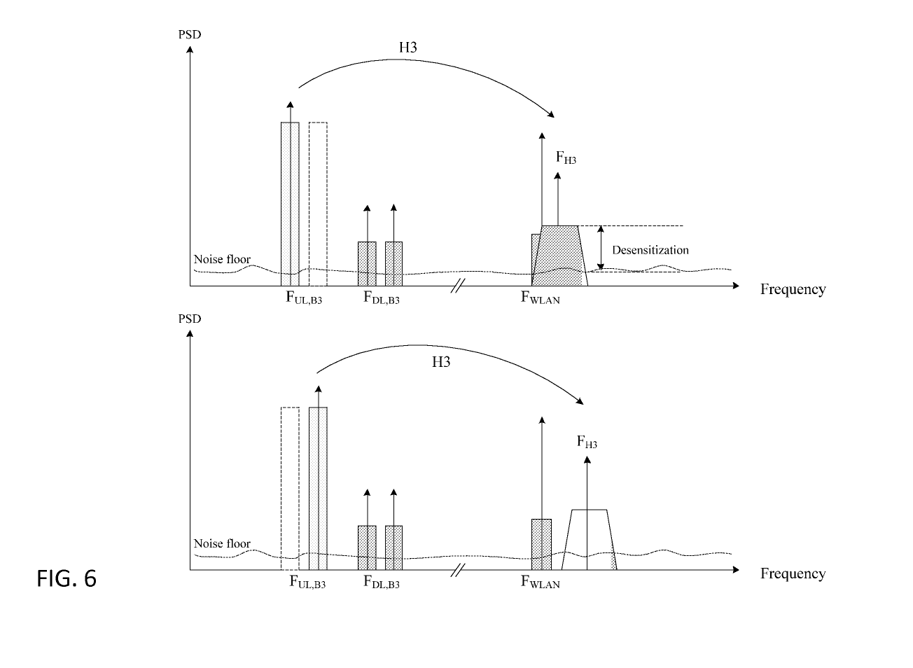

In some embodiments, prioritization of CCs is desired. For example, in the case of B3 intra-band non-contiguous CA, the two UL CCs may have significantly different impacts, for example H3, on 5 GHz WLAN. As depicted in the upper part of FIG. 6, one CC of B3 may produce harmonic distortion in the 5 GHz WLAN channel. However, as depicted in the lower part of FIG. 6, another CC of B3 may not produce harmonic distortion in the 5 GHz WLAN channel. Therefore, in embodiments, it is preferred to prioritize the CC whose H3 does not produce H3 in the 5 GHz WLAN channel that the UE uses and the UE indicates such a CC preference to the network accordingly.

In embodiments, the indication further comprises an indication of at least one preferred CC configuration within the at least one preferred uplink carrier band. The at least one preferred CC configuration may for example relate to a preferred CC configuration for intra-band non-contiguous carrier aggregation.

In embodiments, the interference scenario comprises one or more uplink and/or downlink carrier bands producing a harmonic distortion on one or more other uplink and/or downlink carrier bands.

In embodiments, the interference scenario comprises one or more uplink and/or downlink carrier bands producing a desensitisation above a given threshold on one or more other uplink and/or downlink carrier bands.

Embodiments can be applied to cellular-to-cellular systems. However, embodiments also apply to inter-RAT cases as well where an eNB will typically have less control and knowledge on UE capabilities and other RAT activities.

In some embodiments, the interference scenario comprises an inter-radio access technology interference scenario between a given combination of uplink and/or downlink carrier bands associated with two or more different radio access technologies. In such embodiments, at least one of the two or more different radio access technologies comprises a cellular network radio access technology and at least one of the two or more different radio access technologies comprises a non-cellular network radio access technology.

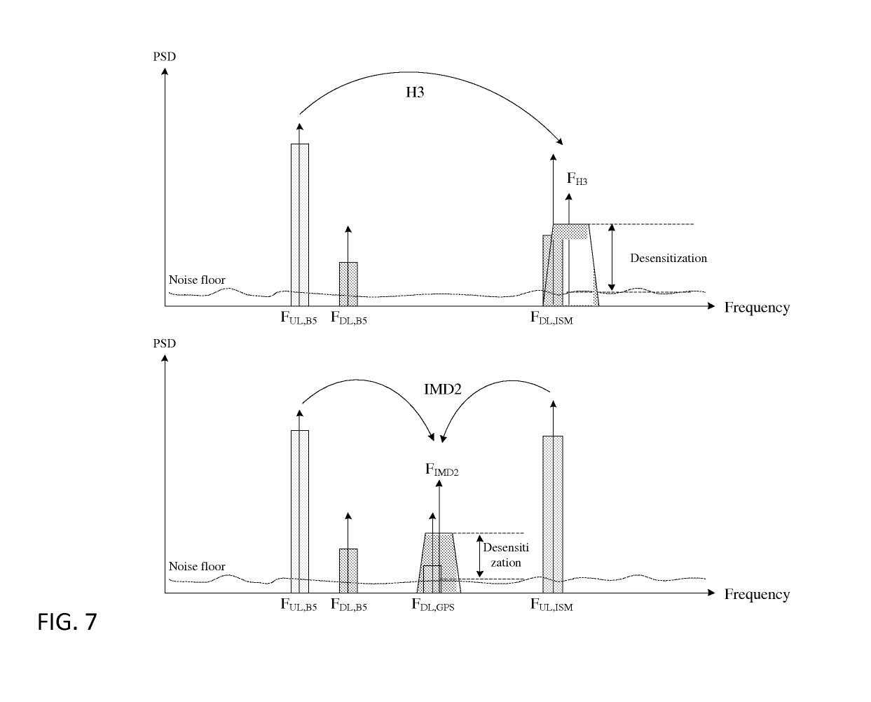

For example, in an example inter-RAT case, the UE could support for example LTE bands 1, 2, 4, 5, 8, 17. Considering a UE operates in a CA case B5+B17 and first at B5 and the user then wants to use 2.4-GHz ISM radio as well. It is possible that B5 UL causes 3rd harmonic distortion in the 2.4-GHz frequency area as shown in the upper part of FIG. 7. Additionally, concurrently operating B5 and 2.4-GHz ISM radios can cause intermodulation on a 1.575-GHz GPS receiver, as shown in the lower part of FIG. 7. In such a case, according to embodiments, the UE transmits a request to a network node such as an eNB to switch to another supported UL cellular band, for example B17, in order to avoid potential in-device coexistence problems.

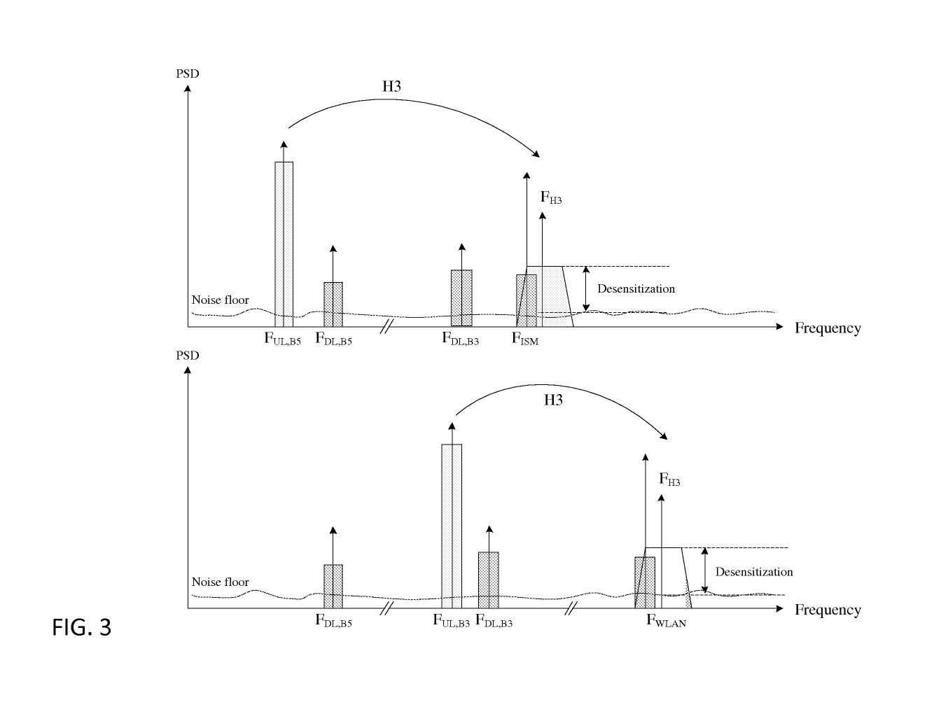

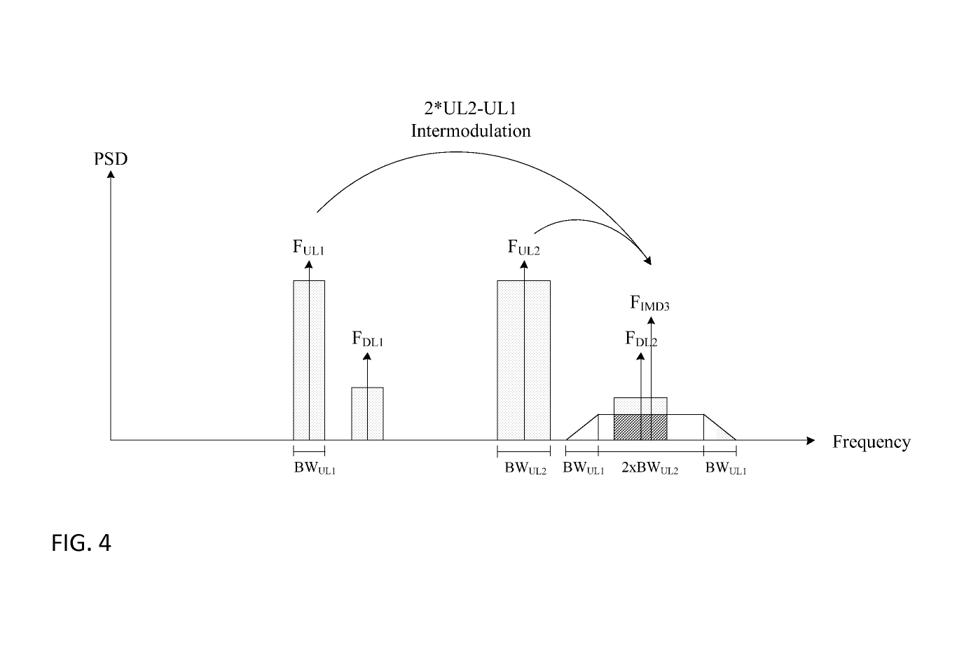

In a CA case of B5+B3 as shown in FIG. 3, the co-existence and potential desensitization of 2.4-GHz ISM and 5-GHz WLAN receivers could be avoided if active cellular UL was chosen appropriately according to embodiments. Also, as mentioned above, concurrently operating B7 UL and 2.4-GHz ISM radios can cause desensitization on the B7 DL. Therefore, CA cases where B7 is aggregated (for example B1+B7, B2+B7, B3+B7, B4+B7 and B20+B7) can benefit from embodiments of the present disclosure.

In other embodiments, the interference scenario comprises an intra-radio access technology interference scenario between a given combination of uplink and/or downlink carrier bands associated with a single radio access technology.

Embodiments comprising carrying out the transmission of the indication from the UE into the radio network and reception of the indication by the network node as part of a capability signalling process for the UE.

In embodiments, the UE carries out the determination at least on the basis of one or more communication capability characteristics of the user equipment. The user equipment capability characteristics may for example be associated with one or more of linearity, sensitivity, radio frequency filter performance, and spurious rejection.

In embodiments, the UE carries out the determination at least on the basis of one or more of uplink transmit power of one or more uplink carriers, received signal strength of one or more downlink carriers, harmonic performance of one or more uplink and/or downlink carrier bands, carrier frequencies employed within one or more uplink and/or downlink carrier bands, and expected data load of one or more uplink and/or downlink carrier bands.

In embodiments, a preferred UL is signalled by a UE to the NW in a static manner, for example as part of UE capability signalling.

In embodiments, a preferred UL is signalled by a UE to the NW dynamically, so that UE knowledge of certain data is used to determine a preferred uplink carrier band. In dynamic embodiments, a preferred uplink carrier band can change as and when certain data changes. In dynamic embodiments, considering for example a B4+B17 example case, one or more of received signal strength on B4, transmission power on B17 and/or the exact carrier frequencies used within each band can be used to dynamically determine whether there would be a preferred band on which to transmit the single carrier uplink.

According to embodiments of the present disclosure, transmission mode control (i.e. a decision as to whether to conduct a partial denial procedure or not) at the communication element (device/terminal) may comprise hysteresis management functionality which is configured to avoid excessive hysteresis between the transmission modes (with or without partial deactivation). In such hysteresis management, the communication element may base its decision for the applicability of mode switching e.g. on network conditions, any available output power restriction value or values, battery capacity, whether there is a connection to a power supply, which applications/services are active, movement of the device, CA band combination, TX resources, RX resources, or the like.

Other criteria used by the UE to determine its preferred uplink band could depend on whether any non-cellular wireless communication systems are operating, and the respective desensitization which could be tolerated on these systems. Such non-cellular wireless communication systems may comprise satellite-based positioning systems such as GPS, GloNASS, Galileo, Beidou, SBAS, and QZSS, aGPS or any other satellite-based positioning system receiver. Such non-cellular wireless communication systems may comprise non-satellite-based positioning systems such as Bluetooth, WLAN, ZigBee, UWB, RFID, ISM radio, etc.

In embodiments, the determination comprises the UE determining an operational status of a non-cellular wireless communication system transceiver in the plurality of radio transceivers.

In embodiments, the determination comprises the UE determining a given desensitisation level which can be tolerated during active operation of a non-cellular wireless communication system transceiver in the plurality of radio transceivers.

In embodiments, the eNB is not mandated to follow the indicated UE preferred uplink. However, assuming that the eNB is able to follow the UE preference indicated to it be a UE, the eNB may for example configure carrier aggregation for the UE with the preferred uplink that the UE has indicated (as per a static configuration case), or perform a PCell swap when the UE reports that it would prefer a new uplink (as per a dynamic reconfiguration case).

In embodiments, an eNB handles multiple UEs which are indicating a preference for a certain uplink band. In such embodiments, the UE can indicate the importance of the request for use of a preferred UL. The eNB can therefore preferentially follow preferred UL requests with higher importance over those with lower importance.

In embodiments, the indication further comprises a priority level associated with the indication. The priority level may for example comprise one of a number of predefined priority levels.

In embodiments, the in-device interference impact from not changing the uplink CC to the preferred UL signalled to the NW by the UE can be categorized by the UE into one a number of different states, for example {none, minor, medium, severe}. In embodiments, the severity of the in-device coexistence problem which would occur if the eNB chooses not to or is unable to follow the UE preference may be categorized by the UE for example as one of {none, minor, medium or severe}. By indicating both the preferred uplink band and the severity of the issue(s) if it is not followed, the eNB can prioritize the various requests. In embodiments, the eNB processes severe requests as per the preferred requested UL, whereas UE minor requests are kept on their current uplink and/or on non-preferred bands due to load balancing constraints.

In embodiments, the UE deduces a measure of severity of in-device coexistence interference associated with the interference scenario and inserts the deduces measure of in-device coexistence interference severity into the indication transmitted from the UE to the network node. In some embodiments, deducing a measure of severity of in-device coexistence interference associated with the interference scenario comprises calculating a measure of severity of in-device coexistence interference associated with the interference scenario. In other embodiments, measures of severity of in-device coexistence interference associated with one or more different interference scenarios are hard-coded into a memory store of the UE and deducing a measure of severity of in-device coexistence interference associated with an interference scenario comprises retrieving a measure of severity of in-device coexistence interference from such memory store.

In embodiments, the UE categorises the calculated measure of in-device coexistence interference severity into one of a number of predefined in-device coexistence interference severity levels and inserts an identifier for the categorised predefined in-device coexistence interference severity level into the indication transmitted from the UE to the network node.

In embodiments, characterization of the severity of the interference scenario is handled by an eNB pre-configuration of the reporting. In embodiments, the eNB configures the UE only to report a change to a preferred uplink if the severity of the interference scenario exceeds a certain threshold.

In embodiments, the UE only carries out transmittal of the indication to the network node if the measure of in-device coexistence interference severity reaches a predetermined threshold level. In embodiments, if the measure of in-device coexistence interference severity does not reach a predetermined threshold level, transmittal of the indication does not take place.

Embodiments comprise the network node transmitting a configuration message to the UE. The configuration message is operable to configure a predetermined threshold level of in-device coexistence interference severity in the user equipment at which transmittal of the indication should take place. In embodiments, upon receipt of the configuration message from the network node, the UE configures the predetermined threshold level identified in the configuration message. Should the configured predetermined threshold level of in-device coexistence interference severity not be met, then the UE will not transmit an indication of at least one preferred uplink carrier band for at least one of the plurality of radio transceivers to the network node.

In embodiments, characterization of the severity of the interference scenario is defined in terms of a CQI impact, at least for cases where the victim carrier is an LTE carrier.

In embodiments, the UE calculates a measure of channel quality degradation associated with the interference scenario and inserts the calculated measure of channel quality degradation into the indication transmitted from the UE to the network node. The calculated measure of channel quality degradation may for example comprise a CQI measure.

In embodiments, a UE indicates (especially for 3GPP systems) in a quantitative way an estimate of the impact of the in-device coexistence problem, such as for CA B4+B17 indicating the CQI degradation to B4 reception, if the UL is transmitted on B17.

In an example static signalling embodiment, a UE indicates for each supported 2DL CA band combination what its preferred UL band would be. When the network configures a connection with CA, it can choose to take into account the UL preference indicated to it by the UE. In embodiments, the UE indicates whether it has a preference towards a lower or a higher frequency CC within a carrier band.

In an example dynamic signalling embodiment, preferred UL band signalling is transmitted when an in-device interference scenario is detected by the UE as starting to occur. In embodiments, preferred uplink band signalling is transmitted when the severity of the interference scenario changes. In embodiments, the UE provides an indication of the severity of the in-device coexistence interference scenario to the network.

In some static signalling embodiments, a UE indicates a preferred UL CC for each supported intra-band non-contiguous CA band. When the network configures a connection with CA for that UE, it may choose to take into account the UE UL CC preference indicated to it.

In some dynamic signalling embodiments, preferred UL CC signalling is transmitted when an in-device interference scenario is detected by the UE as starting to occur. In embodiments, preferred UL CC signalling is transmitted when the severity of the interference scenario changes. In embodiments, UE signalling includes information relating to a preferred CC in the case of intra-band non-contiguous CA. In embodiments, the UE provides an indication of the severity of the in-device coexistence interference scenario to the network.

In embodiments, the indication is transmitted from the UE and received by the network node in the form of an RRC message.

In embodiments, indication of a preferred UL by a UE is implemented by defining a new RRC message, for example a new RRC message requesting physical channel reconfiguration. An example of such as new RRC message is given as follows:

-- ASN1START

| | |
|---|---|
| RRCPhysicalReconfigurationRequest ::= | SEQUENCE { |

| | |
|---|---|
| criticalExtensions | CHOICE { |

| | |
|---|---|
| rrcReconfigurationRequest-r11 | RRCReconfigurationRequest- |

r11-IEs,

| | |
|---|---|
| criticalExtensionsFuture | SEQUENCE { } |

| | } | |
|---|---|---|
| } | | |
| RRCReconfigurationRequest-r11-IEs ::= | | SEQUENCE { |
| | PreferredULBand | PreferredULBand, |
| | Severity | Severity |

}

| | |
|---|---|
| PreferredULBAND ::= | INTEGER (1..64) |

| | |
|---|---|
| EstCQIDegradation ::= | INTEGER { |

(0..15) }

-- ASN1STOP

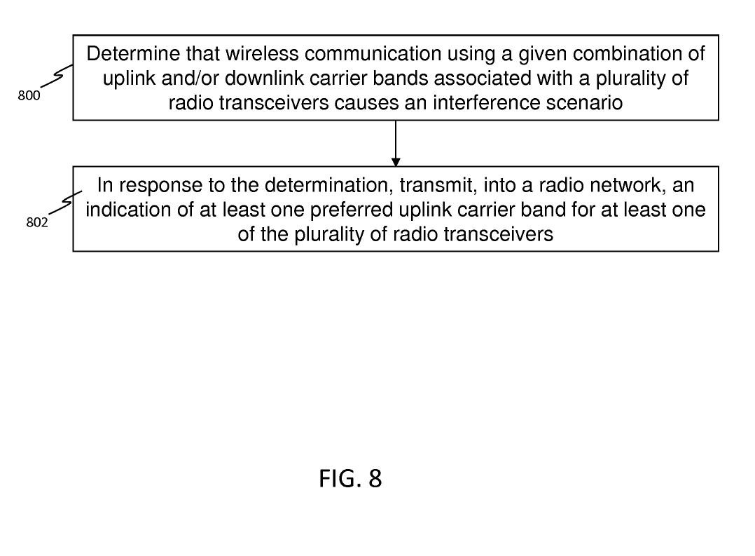

FIG. 8 shows a flowchart according to embodiments of the present disclosure. FIG. 8 depicts steps carried out at a user equipment for mitigating interference in wireless communications of the user equipment comprising a plurality of radio transceivers.

Item 800 involves determining that wireless communication using a given combination of uplink and/or downlink carrier bands associated with the plurality of radio transceivers causes an interference scenario.

Item 802 involves, in response to the determination, transmitting, into a radio network, an indication of at least one preferred uplink carrier band for at least one of the plurality of radio transceivers.

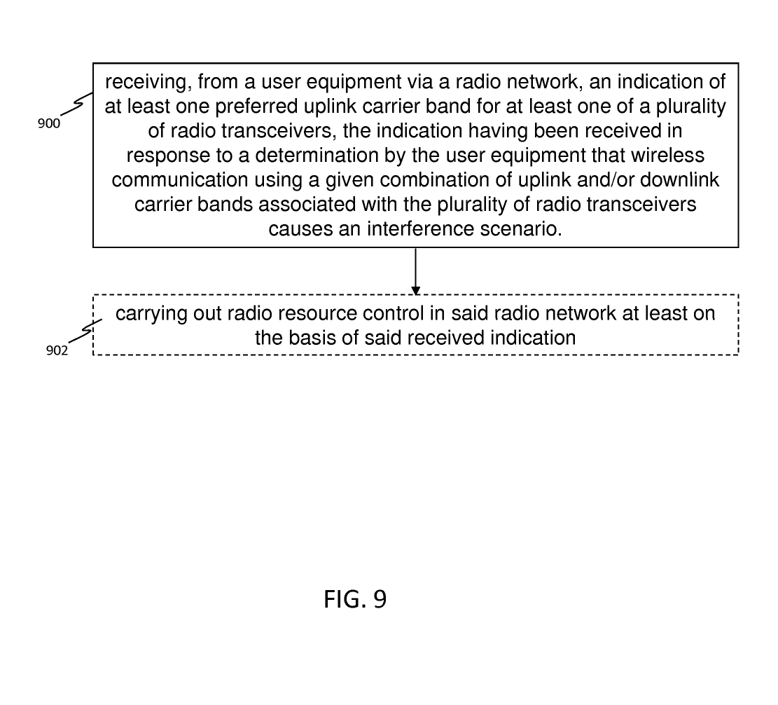

FIG. 9 shows a flowchart according to embodiments of the present disclosure. FIG. 9 depicts steps carried out at a network node for mitigating interference in wireless communications of a user equipment comprising a plurality of radio transceivers.

Item 900 involves receiving, from the user equipment via a radio network, an indication of at least one preferred uplink carrier band for at least one of the plurality of radio transceivers, the indication having been received in response to a determination by the user equipment that wireless communication using a given combination of uplink and/or downlink carrier bands associated with the plurality of radio transceivers causes an interference scenario.

Item 902 involves an optional step (hence dashed line box instead of solid line box) where the network node may carry out radio resource control in the radio network at least on the basis of received indication.

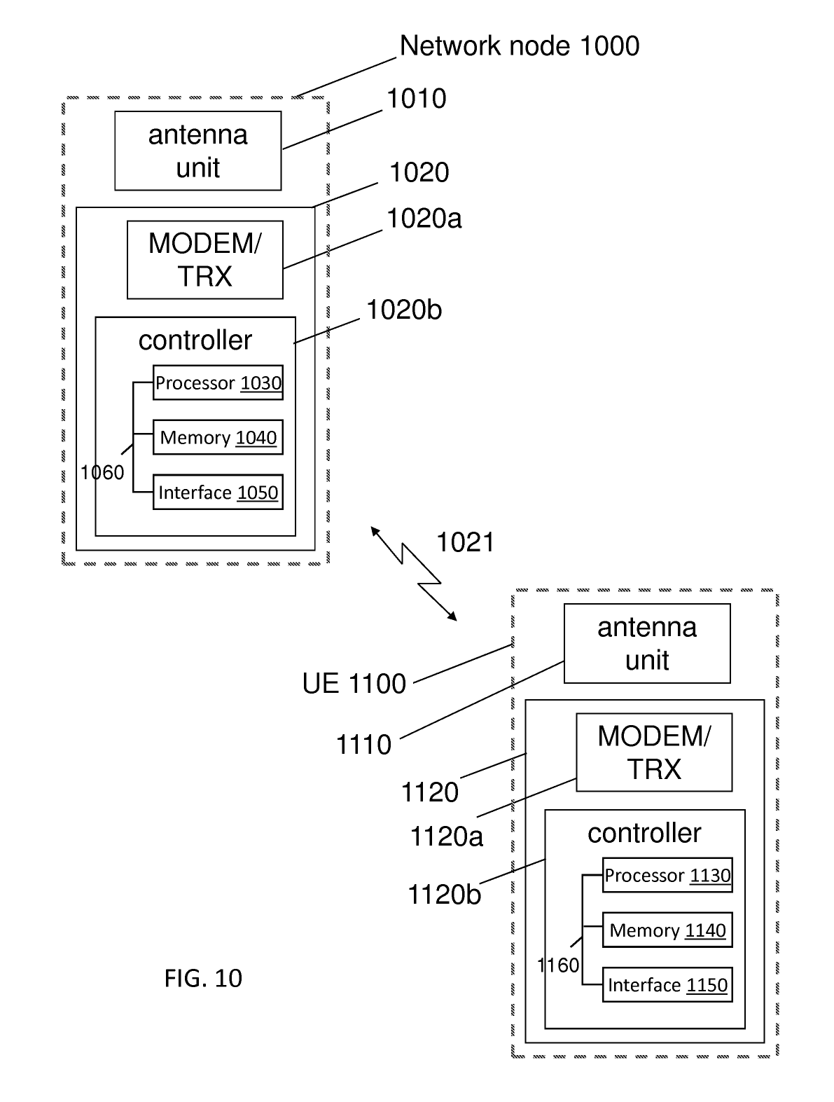

FIG. 10 shows a functional block diagram of apparatus according to embodiments of the present disclosure. FIG. 10 illustrates various electronic devices and apparatus that are suitable for use in a radio (or ‘wireless communications’) network according to embodiments.

FIG. 10 includes a network node (or ‘network entity’, or ‘network device’) apparatus 1000 adapted for communication over wireless link 1021 with an apparatus 1100 such as a mobile terminal or termed more generally as a UE.

Network entity 1000 may comprise one or more of a base station, a base transceiver station, a node B (UMTS), an e-NodeB/eNB (LTE), or an access node, etc.

Network entity 1000 may be further communicatively coupled via a link (not shown) to one or more higher network nodes (not shown), for example including a radio network controller (RNC) in the case of the UMTS system or a mobility management entity/serving gateway MME/S-GW in the case of the LTE system.

As shown in FIG. 10, UE apparatus 1100 according to embodiments of the present disclosure comprises one or more antenna units 1110 and processing units 1120. The processing unit 1120 comprises a plurality of modems/transceivers 1120a and controller units 1120b.

Antenna unit 1110 comprises one or more RX and/or TX antennas (not shown). An antenna unit is for example applicable for use as or in an antenna module or an antenna module with electronics according to embodiments of the present disclosure.

A controller unit 1120b is configured for use in interference mitigation according to embodiments of the present disclosure, as described above. Component 1120a may be realized by a feeding/communication unit which may comprise at least one of a modem and a transceiver unit (in the case of a transmit/receive antenna or corresponding usage). Component 1120b may be realized by a processing system or processor or, as illustrated, by an arrangement of a processor 1130, a memory 1140 and an interface 1150, which are connected by a link or bus 1160. Memory 1140 may store respective programs assumed to include program instructions or computer program code that, when executed by the processor 1130, enable the respective electronic device or apparatus to operate in accordance with the embodiments of the present disclosure. For example, memory 1140 may store a computer-readable implementation of an interference mitigation procedure. Further, memory 1140 may store one or more look-up tables for implementing interference mitigation with respect to the one or more parameters used in this regard, such as look-up tables for different combinations of conceivable parameters for determination of interference scenarios.

Embodiments of the present disclosure may be implemented at least in part by computer software stored in memory 1140 which is executable by processor 1130; or by a processing system; or by hardware, or by a combination of tangibly stored software and hardware (and tangibly stored firmware).

According to embodiments of the present disclosure, all (or some) circuitries required for the aforementioned functionalities may be embedded in the same circuitry, a system in package, a system on chip, a module, a LTCC (Low temperature co-fired ceramic) or the like, as indicated by the dashed line of UE 1100 in FIG. 10.

Irrespective of the illustration of FIG. 10, an apparatus (or electronic device) according to embodiments of the present disclosure may comprise processing unit 1120 only, which is connectable to the antenna unit 1110, or an apparatus (or electronic device) according to embodiments of the present disclosure may comprise controlling unit 1120b only, which is connectable to antenna unit 1110 (via modem/transceiver 1120a or not).

According to embodiments of the present disclosure, interference mitigation procedures may be executed in/by a processing unit 1120 (i.e. in cooperation between a modem/transceiver 1120a and a controller 1120b) or in/by a controller 1120b as such.

As shown in FIG. 10, network entity apparatus 1000 according to embodiments of the present disclosure comprises one or more antenna units 1010 and processing units 1020, wherein a processing unit 1020 comprises one or more modems/transceivers 1020a and controllers 1020b.

An antenna unit 1010 comprises one or more RX and/or TX antennas (not shown). The antenna unit is for example applicable for use as or in an antenna module or an antenna module with electronics according to embodiments of the present disclosure.

A controlling unit 1020b is configured to perform interference mitigation according to embodiments of the present disclosure, as described above. Component 1020a may be realized by a feeding/communication unit which may comprise at least one of a modem and a transceiver unit (in the case of a transmit/receive antenna or corresponding usage). Component 1020b may be realized by a processing system or processor or, as illustrated, by an arrangement of a processor 1030, a memory 1040 and an interface 1050, which are connected by a link or bus 1060. Memory 1040 may store respective programs assumed to include program instructions or computer program code that, when executed by the processor 1030, enable the respective electronic device or apparatus to operate in accordance with the embodiments of the present disclosure. For example, memory 1040 may store a computer-readable implementation of interference mitigation procedures. Further, memory 1040 may store one or more look-up tables for implementing interference mitigation procedures with respect to the one or more parameters used in this regard.

Embodiments of the present disclosure may be implemented at least in part by computer software stored in memory 1040 which is executable by processor 1030; or by a processing system; or by hardware, or by a combination of tangibly stored software and hardware (and tangibly stored firmware).

According to embodiments of the present disclosure, all (or some) circuitries required for the aforementioned functionalities may be embedded in the same circuitry, a system in package, a system on chip, a module, a LTCC (Low temperature co-fired ceramic) or the like, as indicated by the dashed line of network entity 1000 in FIG. 10.

Irrespective of the illustration of FIG. 10, network node apparatus 1000 (or electronic device) according to embodiments of the present disclosure may comprise processing unit 1020 only, which is connectable to the antenna unit 1010, or an apparatus (or electronic device) according to embodiments of the present disclosure may comprise controlling unit 1020b only, which is connectable to antenna unit 1010 (via modem/transceiver 1020a or not).

According to embodiments of the present disclosure, interference mitigation procedures may be executed in/by a processing unit 1020 (i.e. in cooperation between a modem/transceiver 1020a and a controller 1020b) or in/by a controller 1020b as such.

In embodiments, the network node comprises a base station, eNB or any other access point of a communication system.

Electronic devices implementing embodiments need not be the entire UE 1100, or network node 1000, but embodiments may be implemented by one or more components of same such as the above described tangibly stored software, hardware, firmware, or a system-on-a-chip SOC or an application specific integrated circuit ASIC or a digital signal processor DSP or a modem or a subscriber identity module (such as a SIM card).

Various embodiments of UE 1100 may include, but are not limited to: mobile (or ‘cellular’) telephones (including so-called “smart phones”), data cards, USB dongles, personal portable digital devices having wireless communication capabilities including but not limited to laptop/palmtop/tablet computers, digital cameras and music devices, sensor network components and Internet appliances. User equipment 100 may also be referred to as a user terminal or endpoint device.

Various embodiments of memories 1040, 1140 include any data storage technology type which is suitable for the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of processors 1030, 1130 include but are not limited to microprocessors, digital signal processors (DSPs), multi-core processors, general purpose computers, and special purpose computers.

It will be understood that any of processors 1030, 1130 or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with embodiments. In this regard, embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, embodiments also extend to computer software, computer programs, particularly computer programs on or in a carrier, adapted for putting embodiments into practice. The program may be in the form of non-transitory source code, object code, a code intermediate source and object code such as in partially compiled form, or in any other non-transitory form suitable for use in the implementation of processes according to embodiments. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The above embodiments are to be understood as illustrative examples of the present disclosure. Further embodiments are envisaged.

In some embodiments, measures/metrics associated with use or non-use of one or more preferred uplinks are measured, categorised and/or calculated by the UE. In other embodiments, such measures/metrics could be stored in a table in memory 1140 of the UE; in such embodiments, instead of the UE measuring and/or categorising and/or calculating such, the UE can retrieve such from memory storage 1140 accordingly.

Embodiments comprise a method for use in mitigating interference in wireless communications of a user equipment comprising a plurality of radio transceivers, the method comprising, at the user equipment:

determining that wireless communication using a given combination of uplink and/or downlink carrier bands associated with the plurality of radio transceivers causes an interference scenario; and

in response to the determination, transmitting, into a radio network, an indication of at least one preferred downlink carrier band for at least one of the plurality of radio transceivers. Hence, a preferred downlink carrier band can be signalled from the UE to the network node for use in interference mitigation.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

### LIST OF ACRONYMS AND ABBREVIATIONS

### 3GPP 3^{rd} Generation Partnership Project

aGPS assisted global positioning system
A-MPR additional maximum power reduction
APAC asian pacific american caucus
ASIC application specific integrated circuit
BW bandwidth
CA carrier aggregation
CC component carrier
CQI channel quality indicator
DB dual-band
DC dual-carrier
DL downlink
DRAM dynamic random-access memory
DRX discontinuous reception
DSP digital signal processor
eNB evolved node-B
EEPROM electrically erasable programmable read-only memory
E-UTRA evolved universal terrestrial radio access
FDD frequency division duplex
FE front-end
FPGA field programmable gate array
GloNASS global navigation satellite system
GNSS global navigation satellite system
GPS global positioning system
H3 3^{rd} order harmonic distortion
HSDPA high speed downlink packet access
IDC in-device co-existence
IF intermediate frequency
IMD intermodulation distortion
ISM industrial, scientific, and medical
LO local oscillator
LTCC Low temperature co-fired ceramic
LTE(-A) long term evolution (advanced)
MAC medium access control

### MME Mobile Management Entity

NS network signalling
NW network
Pcell primary serving cell
PSD power spectral density
QZSS quasi-zenith satellite system
RAT radio access technology
RF radio frequency
RFIC radio frequency integrated circuit
RFID radio-frequency identification
RNC radio network controller
RRC radio resource control
RX receiver
SBAS satellite-based augmentation system
S-GW serving gateway
SIM subscriber identity module
SNDR signal-to-noise and distortion ratio
SOC system-on-a-chip
SRAM static random-access memory
SSD solid-state drive
SW software
TX transmitter
UE user equipment
UL uplink
USB universal serial bus
UWB ultra-wide band
WiFi wireless fidelity
WLAN wireless local area network

1. A method of mitigating interference in wireless communications of a user equipment comprising a plurality of radio transceivers, the method comprising, at the user equipment:
determining that wireless communication using a given combination of uplink and/or downlink carrier bands associated with said plurality of radio transceivers causes an interference scenario; and
in response to said determination, transmitting, into a radio network, an indication of at least one preferred uplink carrier band for at least one of said plurality of radio transceivers.

2. (canceled)

3. (canceled)

4. A method according to claim 1, wherein said radio network comprises a cellular network and said indication comprises an indication of at least one preferred uplink carrier band for said cellular network.

5. A method according to claim 1, wherein said plurality comprises at least one uplink transmitter and at least two downlink receivers and said indication comprises an indication of at least one preferred uplink carrier band for said at least one uplink transmitter for use during downlink carrier aggregation via said at least two downlink receivers.

6. A method according to claim 1, wherein said plurality comprises at least two uplink transmitters and at least two downlink receivers and said indication comprises an indication of at least one preferred uplink carrier band for one or more of said at least two uplink transmitters for use during downlink carrier aggregation via said at least two downlink receivers and uplink carrier aggregation via said at least two uplink transmitters.

7. A method according to claim 1, wherein said indication further comprises an indication of at least one preferred component carrier configuration within said at least one preferred uplink carrier band.

8. (canceled)

9. (canceled)

10. (canceled)

11. A method according to claim 1, comprising deducing a measure of severity of in-device coexistence interference associated with said interference scenario,
wherein said indication further comprises said deduced measure of in-device coexistence interference severity.

12. (canceled)

13. (canceled)

14. (canceled)

15. A method according to claim 1, comprising calculating a measure of channel quality degradation associated with said interference scenario,
wherein said indication further comprises said calculated measure of channel quality degradation.

16. (canceled)

17. (canceled)

18. (canceled)

19. (canceled)

20. (canceled)

21. (canceled)

22. (canceled)

23. (canceled)

24. A method according to claim 1, wherein said determination is carried out at least on the basis of one or more communication capability characteristics of said user equipment, said user equipment capability characteristics being associated with one or more of:
linearity,
sensitivity,
selectivity,
blocking immunity,
radio frequency filter performance, and
spurious response rejection.

25. A method according to claim 1, wherein said determination is carried out at least on the basis of one or more of:
uplink transmit power of one or more uplink carriers,
received signal strength of one or more downlink carriers,
harmonic performance of one or more uplink and/or downlink carrier bands,
carrier frequencies employed within one or more uplink and/or downlink carrier bands, and
expected data load of one or more uplink and/or downlink carrier bands.

26. (canceled)

27. (canceled)

28. (canceled)

29. (canceled)

30. Apparatus for use in mitigating interference in wireless communications of a user equipment comprising a plurality of radio transceivers, the apparatus being adapted to, at the user equipment:
determine that wireless communication using a given combination of uplink and/or downlink carrier bands associated with said plurality of radio transceivers causes an interference scenario; and
in response to said determination, transmit, into a radio network, an indication of at least one preferred uplink carrier band for at least one of said plurality of radio transceivers.

31. (canceled)

32. (canceled)

33. (canceled)

34. Apparatus according to claim 30, wherein said plurality comprises at least one uplink transmitter and at least two downlink receivers and said indication comprises an indication of at least one preferred uplink carrier band for said at least one uplink transmitter for use during downlink carrier aggregation via said at least two downlink receivers.

35. Apparatus according to claim 30, wherein said plurality comprises at least two uplink transmitters and at least two downlink receivers and said indication comprises an indication of at least one preferred uplink carrier band for one or more of said at least two uplink transmitters for use during downlink carrier aggregation via said at least two downlink receivers and uplink carrier aggregation via said at least two uplink transmitters.

36. Apparatus according to claim 30, wherein said indication further comprises an indication of at least one preferred component carrier configuration within said at least one preferred uplink carrier band.

37. (canceled)

38. (canceled)

39. (canceled)

40. Apparatus according to claim 30, said apparatus being adapted to deduce a measure of severity of in-device coexistence interference associated with said interference scenario,
wherein said indication further comprises said deduced measure of in-device coexistence interference severity.

41. (canceled)

42. (canceled)

43. (canceled)

44. Apparatus according to claim 30, said apparatus being adapted to calculate a measure of channel quality degradation associated with said interference scenario,
wherein said indication further comprises said calculated measure of channel quality degradation.

45. (canceled)

46. (canceled)

47. (canceled)

48. (canceled)

49. (canceled)

50. (canceled)

51. (canceled)

52. (canceled)

53. Apparatus according to claim 30, said apparatus being adapted to carry out said determination at least on the basis of one or more communication capability characteristics of said user equipment, said user equipment capability characteristics being associated with one or more of:
linearity,
sensitivity,
selectivity,
blocking immunity,
radio frequency filter performance, and
spurious response rejection.

54. Apparatus according to claim 30, said apparatus being adapted to carry out said determination at least on the basis of one or more of:
uplink transmit power of one or more uplink carriers,
received signal strength of one or more downlink carriers,
harmonic performance of one or more uplink and/or downlink carrier bands,
carrier frequencies employed within one or more uplink and/or downlink carrier bands, and
expected data load of one or more uplink and/or downlink carrier bands.

55-85. (canceled)

86. Apparatus for use in mitigating interference in wireless communications of a user equipment comprising a plurality of radio transceivers, the apparatus being adapted to, at a network node:
receive, from the user equipment via a radio network, an indication of at least one preferred uplink carrier band for at least one of said plurality of radio transceivers, said indication having been received in response to a determination by said user equipment that wireless communication using a given combination of uplink and/or downlink carrier bands associated with said plurality of radio transceivers causes an interference scenario.

87. Apparatus according to claim 86, said apparatus being adapted to carry out radio resource control in said radio network at least on the basis of said received indication.

88. Apparatus according to claim 86, said apparatus being adapted to initiate configuration of carrier aggregation in said radio network for said user equipment on the basis of said received indication of at least one preferred uplink carrier band.

89.-116. (canceled)
